(19) United States
(12) Patent Application Publication
(10) Pub. No.: US 2018/0348691 A1
(43) Pub. Date: Dec. 6, 2018

(54) IMAGE FORMING SYSTEM AND SHEET CONVEYING APPARATUS

(71) Applicant: CANON KABUSHIKI KAISHA, Tokyo (JP)

(72) Inventor: Noriaki Koyanagi, Toride-shi (JP)

(21) Appl. No.: 15/988,480

(22) Filed: May 24, 2018

(30) Foreign Application Priority Data
Jun. 2, 2017 (JP) 2017-110449

(51) Int. Cl. G03G 15/00; G03G 15/16; B65H 5/06; G03G 15/20; G03G 21/20

(52) U.S. Cl. CPC G03G 15/6529; G03G 15/6508; G03G 21/206; B65H 5/062; G03G 15/2064; G03G 15/161

(57) ABSTRACT

An image forming system including: an image forming apparatus having an image forming portion configured to form an image on a sheet and a discharge portion configured to discharge, in a sheet discharge direction, the sheet on which the image is formed by the image forming portion; a sheet processing apparatus opposed to a side surface of the image forming apparatus on a downstream side in the sheet discharge direction and configured to process the sheet; a sheet conveying apparatus, which includes a sheet conveying path through which the sheet is conveyed, is removably mounted to the image forming apparatus, and is configured to convey the sheet discharged from the discharge portion to the sheet processing apparatus through the sheet conveying path; and an air flow generator arranged in the sheet conveying apparatus and configured to generate an air flow which flows through the sheet conveying path.

### BACKGROUND OF THE INVENTION

### Field of the Invention

The present invention relates to a sheet conveying apparatus, which is configured to convey a sheet, and an image forming system including the sheet conveying apparatus.

### Description of the Related Art

Hitherto, there has been known an image forming apparatus of a so-called in-body delivery type, which is configured to form an image on a sheet by an image forming portion employing an electrophotographic system or other such systems, and discharge the sheet to a delivery space defined in a space occupied by a main body. There has also been known an image forming system including the image forming apparatus of the in-body delivery type, a sheet processing apparatus arranged on a lateral side of the image forming apparatus, and a sheet conveying unit mounted in the delivery space. In the image forming system, the sheet discharged from the image forming apparatus is conveyed to the sheet processing apparatus through the sheet conveying unit, and is subjected to a binding process, an alignment process, and other such processes as necessary.

Incidentally, in an image forming apparatus employing the electrophotographic system, there is widely employed a heat fixing system in which a sheet having a toner image transferred thereto is heated to melt toner particles and form a toner layer adhering to the sheet such that the image is fixed to the sheet serving as a recording medium. In Japanese Patent Application Laid-Open No. 2011-242635, there is described an image forming apparatus including a main body, a delivery conveyance portion, and a finisher. The main body includes a fixing portion of the heat fixing system. The delivery conveyance portion is provided in an in-body delivery space of the main body. The finisher is configured to receive a sheet from the delivery conveyance portion and perform post-processing on the sheet. This image forming apparatus includes an air passage, which is capable of forming an air curtain that separates the delivery conveyance portion and toner bottles arranged below the delivery conveyance portion, in the main body, to suppress transfer of heat from a paper sheet conveyed inside the delivery conveyance portion to the toner bottles.

Incidentally, in an image forming apparatus employing the heat fixing system, there is known a phenomenon in which, when a plurality of sheets are stacked under a state in which the sheets are cooled unsatisfactorily after a fixing step, toner is remelted, and the sheets are bonded to each other. However, with the configuration described in Japanese Patent Application Laid-Open No. 2011-242635, a fan configured to blow air to the air passage is provided outside the delivery conveyance portion, and the sheet that is conveyed through the delivery conveyance portion may sometimes be cooled unsatisfactorily. Therefore, there has been a risk in that the sheets that are transferred from the delivery conveyance portion to the finisher and stacked onto one another may be bonded to one another.

### SUMMARY OF THE INVENTION

In view of the above-mentioned problem, the present invention provides a sheet conveying apparatus, which is configured to efficiently cool a sheet, and an image forming system.

According to one embodiment of the present invention, provided is an image forming system comprising:

an image forming apparatus including:
an image forming portion configured to form an image on a sheet; and
a discharge portion configured to convey and discharge, in a sheet discharge direction, the sheet on which the image has been formed by the image forming portion;

a sheet processing apparatus, which is arranged to be opposed to a side surface of the image forming apparatus on a downstream side in the sheet discharge direction, and is configured to process the sheet;

a sheet conveying apparatus, which includes a sheet conveying path through which the sheet is conveyed, is removably mounted to the image forming apparatus, and is configured to convey the sheet discharged from the discharge portion to the sheet processing apparatus through the sheet conveying path; and

an air flow generator, which is arranged in the sheet conveying apparatus, and is configured to generate an air flow which flows through the sheet conveying path.

Further features of the present invention will become apparent from the following description of exemplary embodiments with reference to the attached drawings.

### BRIEF DESCRIPTION OF THE DRAWINGS

FIG. 1 is a schematic view for illustrating a configuration of an image forming apparatus according to the present disclosure.

FIG. 2A is a front view of an image forming system according to a first embodiment of the present invention.

FIG. 2B is a schematic view for illustrating an internal configuration of the image forming system according to the first embodiment.

FIG. 3A is a schematic view of a sheet processing mechanism in the first embodiment.

FIG. 3B is a schematic view of an intermediate conveyance unit.

FIG. 4 is a block diagram for illustrating a control configuration of the image forming system according to the first embodiment.

FIG. 5 is a flow chart for illustrating a method of controlling the image forming system according to the first embodiment.

FIG. 6A is a front view of an image forming system according to a modification example of the first embodiment.

FIG. 6B is a schematic view for illustrating the internal configuration of the image forming system according to the modification example of the first embodiment.

FIG. 7A is a front view of an image forming system according to a second embodiment of the present invention.

FIG. 7B is a schematic view for illustrating an internal configuration of the image forming system according to the second embodiment.

FIG. 8A is a front view of an image forming system according to a third embodiment of the present invention.

FIG. 8B is a schematic view for illustrating an internal configuration of the image forming system according to the third embodiment.

### DESCRIPTION OF THE EMBODIMENTS

Now, an image forming system according to the present disclosure will be described with reference to the drawings. The image forming system includes an image forming apparatus having a printing function of forming an image on a recording medium, and apparatus additionally mounted to and used with the image forming apparatus. In this embodiment, description is made of an image forming system including the image forming apparatus, a sheet processing apparatus, and a sheet conveying apparatus configured to convey a sheet-like recording medium (hereinafter referred to as “sheet”) discharged from the image forming apparatus to the sheet processing apparatus. However, the present invention is also applicable to an image forming system including an apparatus (for example, a sheet feeding apparatus configured to feed a sheet to the image forming apparatus) other than the sheet processing apparatus and the sheet conveying apparatus. Moreover, sheets include sheets made of any material such as copy paper sheets or other such paper sheets, plastic films for an overhead projector, and cloth as well as sheets having any shape such as envelopes and index sheets.

(Image Forming Apparatus)

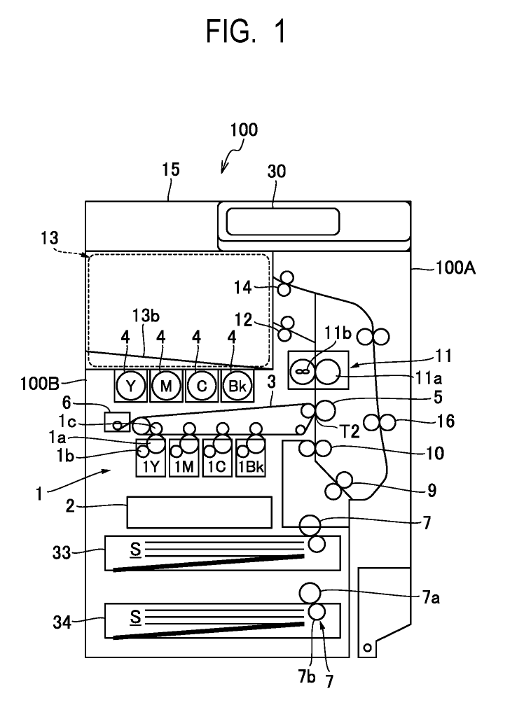

First, a configuration of a printer, which is an example of the image forming apparatus, will be described with reference to FIG. 1. As illustrated in FIG. 1, a printer 100 includes a printer main body 100A and an image reading portion 15. The printer main body 100A is a main body configured to house an image forming portion 1 employing an electrophotographic system. The image reading portion 15 is mounted on top of the printer main body 100A. The printer 100 is configured to form an image on a sheet S based on image information read from an original by the image reading portion 15 or image information input from an external device, and to output the sheet S having the image formed thereon.

The image reading portion 15 includes an original feeding portion and a reading portion. The original feeding portion is configured to automatically feed a sheet being the original. The reading portion is capable of reading the image information by optically scanning the sheet fed by the original feeding portion and converting an image acquired by the optical scanning into an electronic signal. As the reading portion, there may be employed a CCD system formed of a combination of a reduction optical system and a charge-coupled device (CCD), or a CIS system formed of a combination of an equal-magnification optical system and a contact image sensor (CIS). Moreover, on top of the printer main body 100A, there is provided an operation portion 30 including a liquid crystal panel and various operation buttons serving as a user interface.

The image forming portion 1 is a tandem-type intermediate transfer system including image forming units 1Y, 1M, 1C, and 1Bk corresponding to respective colors of yellow (Y), magenta (M), cyan (C), and black (Bk), an intermediate transfer belt 3, and a fixing device 11. The configurations of the image forming units 1Y to 1Bk are basically the same except that the color of the toner used for developing is different. Therefore, the configuration and operation of the image forming units will be described taking the yellow image forming unit 1Y as an example.

When a request to form a toner image is given to the image forming unit 1Y, a photosensitive drum 1a, which is a drum-shaped photosensitive member, is driven to rotate, and a charging device uniformly charges the surface of the photosensitive drum 1a. An exposure device 2, which is provided below the image forming units 1Y to 1Bk, irradiates the photosensitive drum 1a with laser beam based on the image information to expose the drum surface, to thereby form an electrostatic latent image on the photosensitive drum 1a. Then, the electrostatic latent image is formed into a visible image (developed) with the toner supplied from a developing device 1b to form the toner image on the surface of the photosensitive drum 1a.

Also in the image forming units 1M, 1C, and 1Bk, toner images of the corresponding colors are formed on the photosensitive drums. The toner images formed by the image forming units 1Y to 1Bk are primarily transferred to the intermediate transfer belt 3, which serves as an intermediate transfer member, to be superimposed on one another by primary transfer rollers 1c. Adhering substances such as toner remaining on the photosensitive drums are removed by cleaning devices provided to the image forming units 1Y to 1Bk. Above the intermediate transfer belt 3, toner bottles 4 configured to supply the toner to the developing devices 1b of the image forming units 1Y to 1Bk are removably mounted.

The intermediate transfer belt 3 is wound around a secondary transfer inner roller, a tension roller, and other such rollers, and is driven to rotate in a direction of rotating with the rotation of the photosensitive drums 1a (in FIG. 1, counterclockwise direction). The toner images borne on the intermediate transfer belt 3 are secondarily transferred to the sheet S at a secondary transfer portion T2 formed by a secondary transfer roller 5, which is opposed to the secondary transfer inner roller, and the intermediate transfer belt 3. Adhering substances such as the toner remaining on the intermediate transfer belt 3 are removed by a belt cleaning device 6. The secondary transfer roller 5 is an example of a transfer portion configured to transfer the toner images to the sheet S. In an image forming portion employing a direct transfer system, for example, a transfer roller and other such transfer devices correspond to the transfer portion. The sheet S having the toner images transferred thereon is passed to the fixing device 11. The fixing device 11 includes a fixing roller pair 11a and a heat source 11b. The fixing roller pair 11a is configured to convey the sheet S while nipping the sheet S. The heat source 11b is, for example, a halogen heater, and a heating portion configured to heat the toner images on the sheet S conveyed by the fixing roller pair 11a. The fixing device 11 applies heat and pressure on the toner images while conveying the sheet S. With this action, the toner is melted and adheres to the sheet S, thereby fixing the image on the sheet S.

Along with the above-mentioned image forming process, a sheet feed portion, which is provided in a lower portion of the printer main body 100A, performs a feed operation of feeding the sheet S from feed cassettes 33 and 34 to the image forming portion 1. The sheet feed portion includes the feed cassettes 33 and 34 serving as sheet storage portions, and feed units 7 configured to feed the sheet S from the feed cassettes 33 and 34. The feed units 7 each include a feed roller 7a and a separation roller 7b. The feed roller 7a is configured to send out the sheet S from the feed cassettes 33 and 34. The separation roller 7b is configured to separate the sheet S that is fed by the feed roller 7a from other sheets. The feed units 7 are an example of the sheet feed portion, and may be replaced by another feed mechanism employing a separation pad system or an air feed system.

The sheet S sent out from the feed cassettes 33 and 34 is conveyed to a registration portion 9 and a registration roller 10. The registration portion 9 is configured to perform skew feed correction on the sheet S, and to send out the sheet S to the secondary transfer portion T2 in accordance with a progress of the operation of forming the toner images in the image forming portion 1. Then, the sheet S having the image formed thereon after passing through the secondary transfer portion T2 and the fixing device 11 is discharged to a delivery space 13 by a first discharge roller pair 12. Alternatively, when duplex printing is to be performed, the sheet S is guided by a second discharge roller pair 14, which is arranged above the first discharge roller pair 12, to be sent into a reverse conveyance portion 16 by a switch-back operation of the second discharge roller pair 14, which is a reverse roller pair. The reverse conveyance portion 16 allows the sheet S to be conveyed downward to pass the sheet S to the registration portion 9 under a state in which the front and back of the sheet S are reversed. Then, the sheet S having an image formed on the back thereof after passing through the secondary transfer portion T2 and the fixing device 11 is discharged to the delivery space 13 by the first discharge roller pair 12.

Here, the printer 100 is an image forming apparatus of a so-called in-body delivery type, in which the delivery space 13 is defined in a space occupied by the image forming apparatus. In other words, the delivery space 13 is a space defined between the image reading portion 15 and a delivery stacking portion 13b, which is provided in an upper portion of the printer main body 100A, in a vertical direction, and is open toward downstream (in FIG. 1, left side) in a sheet discharge direction of the first discharge roller pair 12. Moreover, the first discharge roller pair 12 and the second discharge roller pair 14 are located at positions retreated to an upstream side in the sheet discharge direction with respect to a side surface 100B of the printer main body 100A on a downstream side in the sheet discharge direction. The printer 100 can be used as an image forming apparatus that is independent even under a state in which a post-processing apparatus, which will be described later, and other such apparatus are not mounted thereon. In that case, the sheet S discharged from the first discharge roller pair 12 is stacked on the delivery stacking portion 13b.

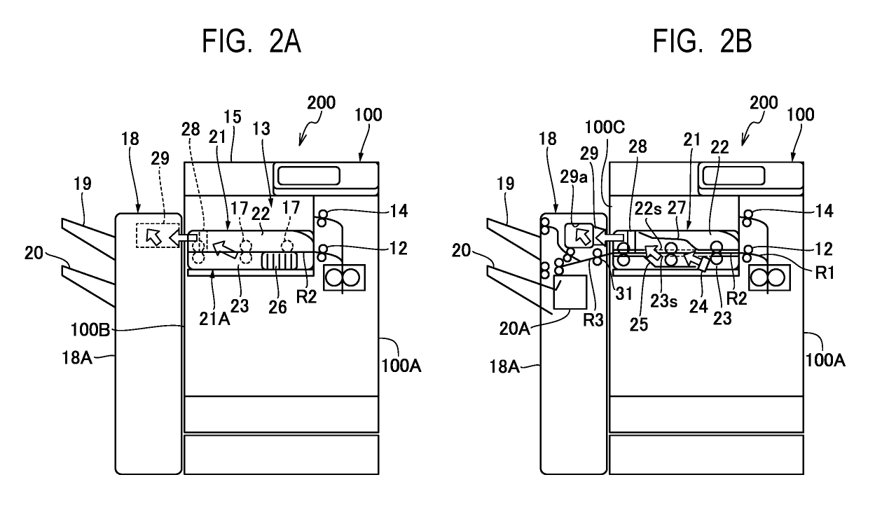

As illustrated in FIG. 2A, an intermediate conveyance unit 21 serving as the sheet conveying apparatus and a post-processing apparatus 18 serving as the sheet processing apparatus can be connected to the printer 100. The intermediate conveyance unit 21 is removably mounted in the delivery space 13, and is configured to convey the sheet discharged by the first discharge roller pair 12 to the post-processing apparatus 18. The post-processing apparatus 18 includes a staple unit 20A (see FIG. 2B), and is configured to perform a binding process on a bundle of sheets S received from the intermediate conveyance unit 21 and discharge the bound sheets.

The staple unit 20A is an example of a processing portion capable of processing the sheet, and may be replaced by one or more processing portions capable of performing a bookbinding process, for example, center binding, a folding process, a punching process, and an alignment process, for example, offset discharge. Similarly, the intermediate conveyance unit 21 is an example of the sheet conveying apparatus interposed between the image forming apparatus and the sheet processing apparatus, and may have both functions of conveying the sheet and performing the punching process and other such processes on the sheet, for example.

Now, specific configuration examples of an image forming system 200, which is formed by the printer 100, the intermediate conveyance unit 21, and the post-processing apparatus 18 described above, will be described in order.

### First Embodiment

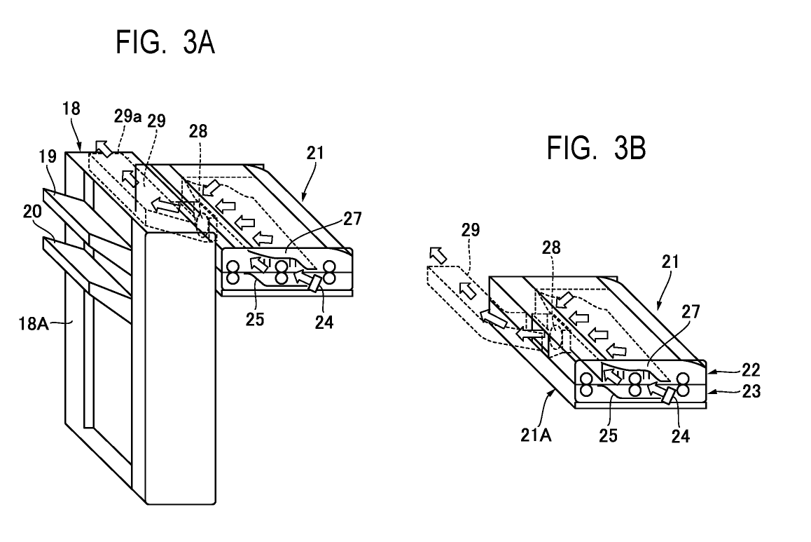

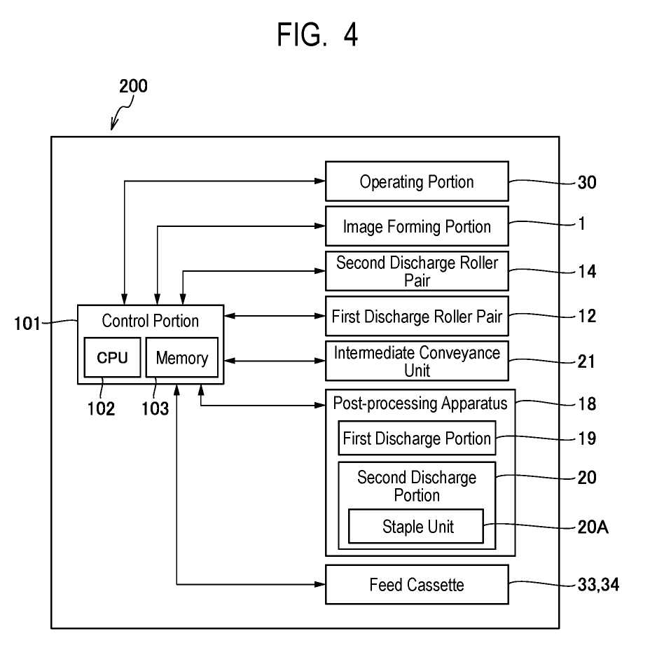

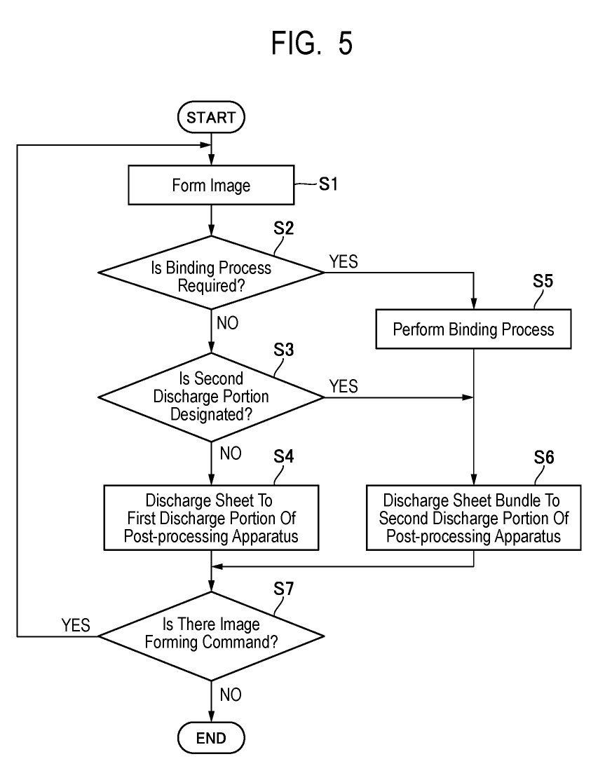

First, the configuration and operation of an image forming system according to a first embodiment of the present invention will be described with reference to FIG. 2A to FIG. 5. FIG. 2A is a front view of the image forming system 200 according to the first embodiment. FIG. 2B is a schematic view of an internal configuration of the image forming system 200. FIG. 3A is a perspective view for schematically illustrating the intermediate conveyance unit 21 and the post-processing apparatus 18, which form the image forming system 200. FIG. 3B is a perspective view for schematically illustrating the intermediate conveyance unit. FIG. 4 is a block diagram for illustrating a control configuration of the image forming system 200. FIG. 5 is a flow chart for illustrating a method of controlling the image forming system 200.

As illustrated in FIG. 2A, the post-processing apparatus 18 is arranged adjacent to the printer main body 100A in a state of being opposed to the side surface 100B of the printer main body 100A on the downstream side in the sheet discharge direction. The intermediate conveyance unit 21 is arranged in the delivery space 13 to connect the first discharge roller pair 12 and the post-processing apparatus 18 to each other.

A housing 21A of the intermediate conveyance unit 21 is formed of an upper guide unit 22 and a lower guide unit 23. The upper guide unit 22 corresponds to a first guide portion. The lower guide unit 23 corresponds to a second guide portion. The lower guide unit 23 is supported by a top plate of the printer main body 100A, which forms a bottom of the delivery space 13. The upper guide unit 22 is supported by the lower guide unit 23. The upper guide unit 22 forms a guide surface opposed to an upper surface of the sheet passing through a relay path R2. The lower guide unit 23 forms a guide surface opposed to a lower surface of the sheet passing through a sheet conveying path. In other words, the guide surfaces of the upper guide unit 22 and the lower guide unit 23 form a guide portion configured to guide the sheet inside the sheet conveying apparatus. One end of the relay path R2 is connected to a discharge path R1 through which the first discharge roller pair 12 discharges the sheet in the printer main body 100A (see FIG. 2B). Moreover, the other end of the relay path R2 is connected to a carry-in path R3 through which a carry-in roller pair 31 receives the sheet in the post-processing apparatus 18.

Inside the intermediate conveyance unit 21, there are arranged, as a sheet conveying portion capable of conveying the sheet, conveyance roller pairs 17 at a plurality of positions along the relay path R2, which is the sheet conveying path. Moreover, the upper guide unit 22 is openable and closable with respect to the lower guide unit 23 about a hinge portion provided on a rear side (far side in FIG. 2A and FIG. 2B) of the printer 100. When the sheet is jammed in the relay path R2, the upper guide unit 22 is lifted to open the relay path R2 and release nip pressures of the conveyance roller pairs 17, to thereby enable an operation of removing the jammed sheet by an operator.

As illustrated in FIG. 2B, the post-processing apparatus 18 includes a first discharge portion 19 and a second discharge portion 20. The first discharge portion 19 includes an upper discharge tray. The second discharge portion 20 includes a lower discharge tray. The second discharge portion 20 is arranged below the first discharge portion 19, and is capable of performing the binding process on the sheets by the staple unit 20A. The post-processing apparatus 18 is configured to guide the sheet received into the carry-in path R3 to any one of branch conveyance paths, perform the binding process as necessary, and discharge the sheet to any one of the first discharge portion 19 and the second discharge portion 20.

Next, description is made of a configuration for allowing the sheet discharged from the printer main body 100A to be cooled within the intermediate conveyance unit 21.

As illustrated in FIG. 3A and FIG. 3B, in the intermediate conveyance unit 21 according to the first embodiment, a cooling fan 24 and an exhaust fan 28 are mounted. Each of the cooling fan 24 and the exhaust fan 28 is an example of an air flow generator configured to generate an air flow inside a housing of a sheet conveying unit. The cooling fan 24 is arranged in the lower guide unit 23. In a front surface of the lower guide unit 23, that is, a side surface of the lower guide unit 23 in a width direction of the sheet, which is orthogonal to the sheet discharge direction, an intake opening 26 (see FIG. 2A), which allows the cooling fan 24 to suck outside air, is formed. Moreover, the exhaust fan 28 is arranged in the upper guide unit 22. In a side surface of the upper guide unit 22 opposed to the post-processing apparatus 18, an opening portion that communicates to a duct (29) provided to the post-processing apparatus 18 is formed.

In the guide surfaces of the upper guide unit 22 and the lower guide unit 23, there are formed slit portions 22s and 23s. The slit portions 22s and 23s have slits through which the air flow generated by the cooling fan 24 and the exhaust fan 28 passes (see FIG. 2B). Inside the lower guide unit 23, there is arranged a cooling duct 25 configured to adjust the air flow sent from the cooling fan 24 toward the relay path R2. Moreover, inside the upper guide unit 22, there is arranged a first exhaust duct 27 configured to adjust the air flow sent from the relay path R2 toward the exhaust fan 28.

The slit portions 22s and 23s are an example of opening portions formed in the guide surfaces of the sheet conveying path, and each may be replaced by a grid of punched holes, for example, or may be formed of opening portions that are connected to one another like a comb guide. Moreover, the cooling duct 25 and the first exhaust duct 27 correspond to a guide portion configured to guide the air flow so as to pass through the sheet conveying path through such opening portions.

The exhaust fan 28 is arranged at a position opposed to an opening portion of an exhaust duct 29 of the post-processing apparatus 18, and is configured to suck air in the first exhaust duct 27 and discharge air toward the second exhaust duct 29 provided in the post-processing apparatus 18. The second exhaust duct 29, which serves as an exhaust portion, has an exhaust opening 29a that is opened in a rear side surface of a housing 18A of the post-processing apparatus 18, and the air sent from the exhaust fan 28 is discharged to the outside of the post-processing apparatus 18 through the exhaust opening 29a. The second exhaust duct 29 forms a path that bypasses a rear wall portion 100C (see FIG. 2B) forming a wall surface on a rear side of the delivery space 13 in the printer main body 100A to discharge air to the outside of the image forming system 200.

In other words, a sheet processing mechanism formed of the intermediate conveyance unit 21 and the post-processing apparatus 18 in the first embodiment cause the cooling fan 24 and the exhaust fan 28, which serve as the air flow generators, to generate the air flow. The intake opening 26, the cooling duct 25, the slit portions 22s and 23s, the first exhaust duct 27, the second exhaust duct 29, and the exhaust opening 29a correspond to an air guide portion configured to allow the air flow generated by the air flow generator to pass through the relay path R2, which serves as the sheet conveying path.

The outside air sucked from the outside of the image forming system 200 through the intake opening 26 by the cooling fan 24 flows into the relay path R2 through the cooling duct 25 and the slit portion 23s, and is blown against the lower surface of the sheet passing through the relay path R2. The air that has cooled the sheet flows from the relay path R2 to the inside of the upper guide unit 22 through the slit portion 22s, and is sucked by the exhaust fan 28 through the first exhaust duct 27. The air sent from the exhaust fan 28 is discharged to the outside of the image forming system 200 through the second exhaust duct 29 and the exhaust opening 29a of the post-processing apparatus 18.

In the printer main body 100A, as illustrated in the block diagram of FIG. 4, there is mounted, as a controller configured to execute centralized control of the image forming system 200, a control portion 101 including a central processing unit (CPU) 102 and a memory 103. The control portion 101 is configured to control operations of components of the image forming system 200 by the CPU 102, which is an execution unit, reading and executing programs stored in the memory 103, which is a storage unit. Specifically, the control portion 101 is capable of controlling operations of the operation portion 30, the image forming portion 1, the first discharge roller pair 12 and the second discharge roller pair 14, the intermediate conveyance unit 21, the first discharge portion 19 and the second discharge portion 20 of the post-processing apparatus 18, and the feed cassettes 33 and 34.

An operation in a case in which an image forming job including a request for sheet processing to be performed by the post-processing apparatus 18 is entered in the image forming system 200 will be described with reference to the flow chart of FIG. 5. When such image forming job is received from the operation portion 30 or an external computer connected to the image forming system 200, the CPU 102 controls the printer 100 to perform an operation of forming an image (Step S1). The printer 100 starts feeding a sheet and forming toner images based on a control signal from the CPU 102, transfers the toner images to the sheet, and then performs a fixing step by the fixing device 11.

The CPU 102 refers to information stored in the memory 103 on attributes (size, type, and the like) of sheets stored in the feed cassettes 33 and 34 and the presence or absence of the sheets. When it is determined that the image forming job can be executed, the CPU 102 gives an instruction to start the operation of forming the image. Moreover, when the binding process and other such post-processing is requested, the CPU 102 checks whether the intermediate conveyance unit 21 and the post-processing apparatus 18 are appropriately connected to the printer 100, whether the post-processing apparatus 18 is of a type capable of performing the requested processing, and the like.

The CPU 102 selects a sheet conveying path in the post-processing apparatus 18 in accordance with a sheet processing method designated by the image forming job. In other words, when the setting of requiring the binding process on the sheet is given (YES in Step S2), the sheet is conveyed toward the second discharge portion 20 including the staple unit 20A, and the binding process is performed by the staple unit 20A (Step S5). A sheet bundle formed by the binding process is discharged to the lower discharge tray by the second discharge portion 20 (Step S6). Moreover, even in a case in which the setting of requiring the binding process is not given (NO in Step S2), when the second discharge portion 20 is designated as a discharge destination of the sheet (YES in Step S3), a discharge operation by the second discharge portion is performed. Meanwhile, when the setting of requiring the binding process is not given (NO in Step S2), and when the second discharge portion 20 is not designated as the discharge destination of the sheet (NO in Step S3), the sheet is discharged to the upper discharge tray by the first discharge portion 19 (Step S4).

Under a state in which image forming and required processing are performed on a predetermined number of sheets (for example, number of sheets in each sheet bundle subjected to the binding process), and when there remains an unfinished task (YES in Step S7), the CPU 102 controls the printer 100 to perform the operation of forming the image successively (Step S1). Meanwhile, when it is determined that the image forming job is complete (NO in Step S7), the CPU 102 ends the job control.

(Effects of the First Embodiment)

As described above, the image forming system 200 of the first embodiment causes the cooling fan 24 and the exhaust fan 28, which are arranged in the intermediate conveyance unit 21, to generate the air flow that passes through the relay path R2 to cool the sheet. In other words, the air flow generator is included in the sheet conveying apparatus, which is removably mounted to the image forming apparatus, to cool the sheet with the air flow generated by the air flow generator. As a result, the sheet that is passed to the post-processing apparatus 18 via the relay path R2 can be efficiently cooled, and the sheets can be prevented from adhering to one another on a discharge tray of the post-processing apparatus 18, for example.

Moreover, the cooling fan 24 cools the sheet with the outside air sucked from the outside of the image forming system 200 through the intake opening 26. In other words, with the configuration in the first embodiment, the sheet is cooled not with air heated inside the printer 100 but with the air introduced from the outside of the image forming system 200. Moreover, the air used for cooling the sheet is discharged to the outside of the image forming system 200 through the exhaust opening 29a via the first exhaust duct 27 and the second exhaust duct 29. All of those features contribute to reducing heat accumulation in and around the delivery space 13, and to maintaining high cooling efficiency for the sheet passing through the relay path R2.

In other words, as compared to the configuration in which the air discharged from the printer main body 100A is guided to the relay path R2 to cool the sheet, for example, even when the operation of forming the image is performed successively on a large volume of sheets, the sheets can be cooled stably. Further, the heat accumulation in and around the delivery space 13 is reduced, and hence in the configuration enabling discharging of the sheet to or above an upper surface of the intermediate conveyance unit 21 by the second discharge roller pair 14, for example, transfer of heat to the discharge sheet can be suppressed.

In particular, in the first embodiment, there is employed the configuration in which the cooling fan 24 is arranged in the lower guide unit 23, and in which the air flow from the cooling fan 24 is blown against the lower surface of the sheet in the relay path R2, that is, the surface to which the toner images are last transferred before the sheet is discharged from the printer main body 100A. The “surface to which the toner images are last transferred” is a surface on which an image is formed by the image forming portion 1 in a case of simplex printing, and is a surface on which an image is formed for the second time by the image forming portion 1 in the case of the duplex printing. With such configuration, a toner layer in a state of being heated by the fixing device 11 is directly cooled by the air flow from the cooling fan 24, and hence cooling efficiency for the sheet can be increased.

(Modification Example)

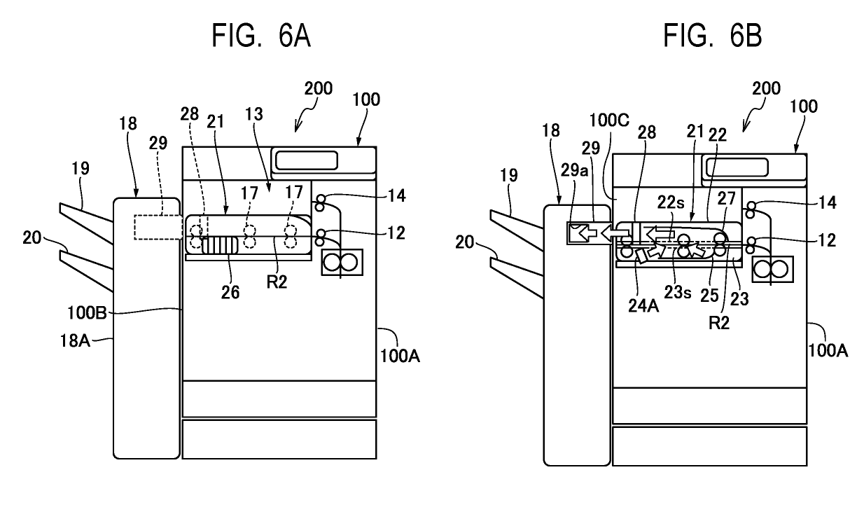

A modification example of the first embodiment will be described with reference to FIG. 6A and FIG. 6B. FIG. 6A is a front view of an image forming system 200 according to the modification example. FIG. 6B is a schematic view for illustrating the internal configuration of the image forming system 200. As illustrated in FIG. 6B, the modification example is different from the first embodiment in that a cooling fan 24A is arranged to be opposed to a sheet conveying direction in the relay path R2.

In other words, the cooling fan 24A is configured to generate an air flow in a direction (toward the right side in FIG. 6B) opposite to the sheet discharge direction by the first discharge roller pair 12 in plan view. Other configurations are common to those in the first embodiment, and air sucked from the intake opening 26 (see FIG. 6A) is blown against the sheet passing through the relay path R2 through the cooling duct 25 and the slit portion 23s of the lower guide unit 23. Then, the air that has cooled the sheet is collected by the exhaust fan 28 through the slit portion 22s of the upper guide unit 22 and the first exhaust duct 27 to be discharged through the second exhaust duct 29. Also with such configuration, the sheet passing through the relay path R2 can be efficiently cooled, and adhesion of the sheets and other such inconvenience can be avoided.

An air flow path in the intermediate conveyance unit 21 can be changed. For example, in a case of the configuration in which the sheet is conveyed in a posture (face-up state) in which a surface to which toner images are last transferred is faced upward, it is preferred that the cooling fan be arranged in the upper guide unit 22. Instead of the configuration in which the air flows through the relay path R2 in the vertical direction (thickness direction of the sheet) through the slit portions 22s and 23s of the guide units 22 and 23, there may be employed the configuration in which the air flows through the relay path R2 from one side to the other side in the width direction of the sheet, for example. Moreover, there may be employed the configuration in which a slit portion is arranged only in the guide surface opposed to the surface to which the toner images are last transferred, and in which the air flow that has been blown against the sheet through the slit portion is discharged from the periphery of the opposing guide surfaces. In short, it is preferred that the specific configuration of the air guide portion forming the air flow path be changed as appropriate in consideration of required cooling efficiency for the sheet, an arrangement space inside the sheet conveying unit, and other such factors.

### Second Embodiment

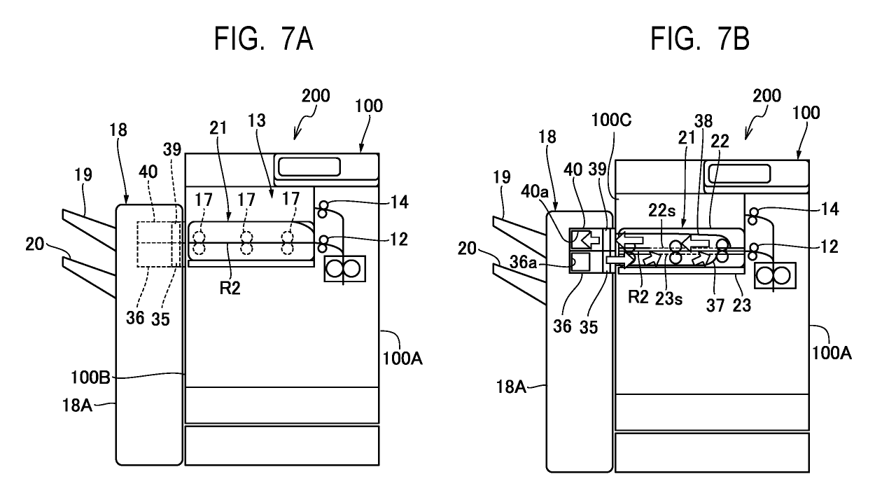

Next, the cooling configuration for a sheet in an image forming system 200 according to a second embodiment of the present invention will be described with reference to FIG. 7A and FIG. 7B. FIG. 7A is a front view of the image forming system 200 according to the second embodiment. FIG. 7B is a schematic view for illustrating the internal configuration of the image forming system 200. In the following description, components common to those in the first embodiment described above are denoted by the same reference symbols, and description thereof is omitted.

As illustrated in FIG. 7A, the image forming system 200 includes a printer 100, an intermediate conveyance unit 21, and a post-processing apparatus 18. The intermediate conveyance unit 21 is removably mounted in a delivery space 13 of the printer 100, and is configured to pass a sheet received from the first discharge roller pair 12 to the post-processing apparatus 18. The post-processing apparatus 18 is configured to perform a binding process and other such processes on the sheet as necessary and discharge the sheet to any one of the first discharge portion 19 and the second discharge portion 20.

As illustrated in FIG. 7A and FIG. 7B, a cooling fan 35 and an exhaust fan 39, which serve as an air flow generator in the second embodiment, are arranged in the post-processing apparatus 18. Moreover, in the post-processing apparatus 18, an intake duct 36 serving as an intake portion and an exhaust duct 40 serving as an exhaust portion are formed. The cooling fan 35 is arranged in the intake duct 36, and the exhaust fan 39 is arranged in the exhaust duct 40. Both of an intake opening 36a of the intake duct 36 and an exhaust opening 40a of the exhaust duct 40 are opened in a rear surface of the housing 18A of the post-processing apparatus 18. Therefore, both of the intake duct 36 and the exhaust duct 40 form an air flow path which bypasses the rear wall portion 100C of the printer main body 100A to communicate the outside of the delivery space 13 with the inside of the intermediate conveyance unit 21.

A lower guide unit 23 of the intermediate conveyance unit 21 includes a cooling duct 37. The cooling duct 37 is connected to the intake duct 36 to guide the air flow from the cooling fan 35, and is configured to the relay path R2 through the slit portion 23s. Moreover, an upper guide unit 22 of the intermediate conveyance unit 21 includes a flowback duct 38. The flowback duct 38 is connected to the exhaust duct 40, and is configured to guide the air flow that flows thereinto from the relay path R2 through the slit portion 22s to the exhaust fan 39.

In the second embodiment, the air sucked from the outside of the image forming system 200 through the intake opening 36a of the intake duct 36 by the cooling fan 35 is blown against a lower surface of the sheet passing through the relay path R2 through the cooling duct 37 and the slit portion 23s. The air that has cooled the sheet flows from the relay path R2 to the inside of the upper guide unit 22 through the slit portion 22s, and flows again to the post-processing apparatus 18 through the flowback duct 38 to be sucked by the exhaust fan 39. Then, the air is discharged to the outside of the image forming system 200 through the exhaust opening 40a of the exhaust duct 40. In other words, the intake opening 36a, the intake duct 36, the cooling duct 37, the slit portions 22s and 23s, the flowback duct 38, the exhaust duct 40, and the exhaust opening 40a form another example of the air guide portion configured to guide the air flow generated by the air flow generator to the sheet conveying path.

Also with such configuration, the sheet passing through the relay path R2 is cooled by the air flow generated by the cooling fan 35 and the exhaust fan 39. Therefore, the sheet that is passed to the post-processing apparatus 18 via the relay path R2 can be efficiently cooled. Moreover, the air for cooling is introduced to the intermediate conveyance unit 21 through the intake duct 36, and the air after cooling the sheet is discharged through the exhaust duct 40, with the result that heat accumulation in and around the delivery space 13 can be reduced.

### Third Embodiment

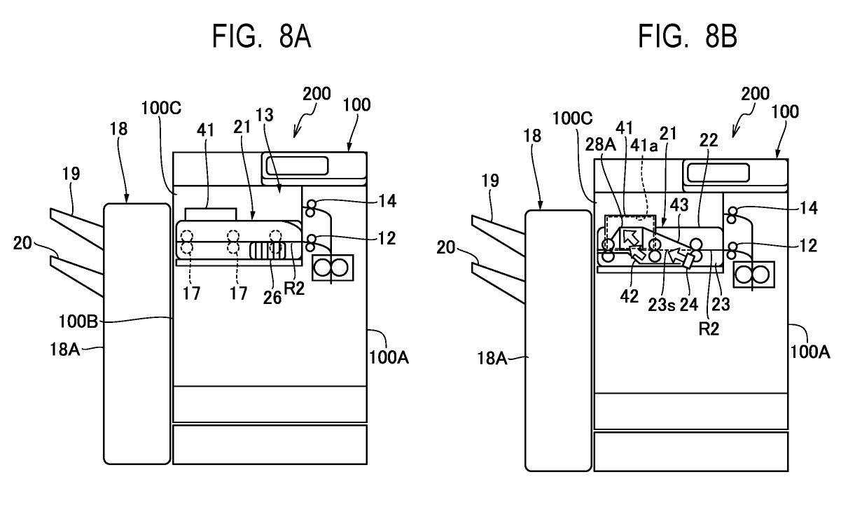

Next, the cooling configuration for a sheet in an image forming system 200 according to a third embodiment of the present invention will be described with reference to FIG. 8A and FIG. 8B. FIG. 8A is a front view of the image forming system 200 according to the third embodiment. FIG. 8B is a schematic view for illustrating the internal configuration of the image forming system 200. In the following description, components common to those in the first embodiment described above are denoted by the same reference symbols, and description thereof is omitted.

As illustrated in FIG. 8A, the image forming system 200 includes a printer 100, an intermediate conveyance unit 21, and a post-processing apparatus 18. The intermediate conveyance unit 21 is removably mounted in a delivery space 13 of the printer 100, and is configured to pass a sheet received from the first discharge roller pair 12 to the post-processing apparatus 18. The post-processing apparatus 18 is configured to perform a binding process and other such processes on the sheet as necessary and discharge the sheet to any one of the first discharge portion 19 and the second discharge portion 20.

As illustrated in FIG. 8A and FIG. 8B, the cooling fan 24 and an exhaust fan 28A, which serve as an air flow generator in the third embodiment, are arranged inside the intermediate conveyance unit 21 similarly to the first embodiment. The exhaust fan 28A is opposed to a main body duct 41, which is provided in a rear wall portion 100C of a printer main body 100A. The main body duct 41 is opened at one end in the delivery space 13, and is opened at an exhaust opening 41a, which is provided at the other end, to the outside of a housing of the printer main body 100A (for example, in a rear surface of the housing). In other words, the main body duct 41 corresponds to a communication portion configured to communicate the delivery space to a space outside the image forming apparatus. Meanwhile, the cooling fan 24 is arranged in a lower guide unit 23 to suck the outside air through an intake opening 26, which is formed in a front surface of the lower guide unit 23.

The lower guide unit 23 of the intermediate conveyance unit 21 includes a cooling duct 42. The cooling duct 42 is configured to guide the air flow from the cooling fan 24 to the relay path R2 through the slit portion 23s. Moreover, an upper guide unit 22 of the intermediate conveyance unit 21 includes an exhaust duct 43. The exhaust duct 43 is connected to the main body duct 41, and is configured to guide the air flow that flows thereinto from the relay path R2 through the slit portion 22s to the exhaust fan 28A.

In the third embodiment, the air sucked from outside the image forming system 200 through the intake opening 26 by the cooling fan 24 is blown against a lower surface of the sheet passing through the relay path R2 through the cooling duct 42 and the slit portion 23s. The air that has cooled the sheet flows from the relay path R2 to the inside of the upper guide unit 22 through the slit portion 22s, and is sucked by the exhaust fan 28A through the exhaust duct 43. Then, the air that has been sent from the exhaust fan 28A is discharged to the outside of the image forming system 200 through the main body duct 41. In other words, the intake opening 26, the cooling duct 42, the slit portions 22s and 23s, the exhaust duct 43, and the main body duct 41 form another example of the air guide portion configured to guide the air flow generated by the air flow generator to the sheet conveying path.

Also with such configuration, the sheet passing through the relay path R2 is cooled by the air flow generated by the cooling fan 24 and the exhaust fan 28A. Therefore, the sheet that is passed to the post-processing apparatus 18 via the relay path R2 can be efficiently cooled. Moreover, the air for cooling is introduced to the intermediate conveyance unit 21 through the intake opening 26, and the air after cooling the sheet is discharged through the main body duct 41, with the result that heat accumulation in and around the delivery space 13 can be reduced.

### Other Embodiments

In each of the first embodiment to the third embodiment described above, there has been described the configuration in which air is blown toward the relay path by the cooling fan, and in which the air that has passed through the relay path is exhausted by the exhaust fan. However, there may be employed the configuration in which any one of the cooling fan and the exhaust fan is omitted, and in which another one of the cooling fan and the exhaust fan is used to generate the air flow. It is preferred to simultaneously provide the cooling fan serving as an air blower (intake portion) and the exhaust fan serving as an exhaust portion from the viewpoints of increasing cooling efficiency and reducing noise because a stable air flow is generated irrespective of the sheet size and other such conditions.

Moreover, in each of the first embodiment to the third embodiment, there has been described the printer 100 including, as the image forming portion, the image forming portion 1 employing the electrophotographic system and a heat fixing system, but the present invention may be applied to an image forming apparatus including another image forming mechanism, for example, an inkjet system. For example, in the configuration employing the inkjet system, an ink solvent can be efficiently dried by the configuration in the embodiments. Without limiting to the heat fixing system, the cooling configuration in the embodiments can also be applied to a case in which a sheet is heated to promote curing reaction in the configuration in which an image containing a photocurable resin component is cured using ultraviolet light, for example. In other words, with this technology, without limiting to the purpose of preventing adhesion between the sheets in the heat fixing system, the air can be blown against the sheet inside the sheet conveying unit configured to convey the sheet between the image forming apparatus and the sheet processing apparatus to stabilize the state of the sheet after the image is formed.

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-110449, filed Jun. 2, 2017, which is hereby incorporated by reference herein in its entirety.

What is claimed is:

1. An image forming system comprising:
an image forming apparatus including:
an image forming portion configured to form an image on a sheet; and
a discharge portion configured to convey and discharge, in a sheet discharge direction, the sheet on which the image has been formed by the image forming portion;
a sheet processing apparatus, which is arranged to be opposed to a side surface of the image forming apparatus on a downstream side in the sheet discharge direction, and is configured to process the sheet;
a sheet conveying apparatus, which includes a sheet conveying path through which the sheet is conveyed, is removably mounted to the image forming apparatus, and is configured to convey the sheet discharged from the discharge portion to the sheet processing apparatus through the sheet conveying path; and
an air flow generator, which is arranged in the sheet conveying apparatus, and is configured to generate an air flow which flows through the sheet conveying path.

2. An image forming system according to claim 1, wherein the sheet conveying apparatus has an intake opening through which outside air is sucked, and
wherein the air flow generator generates the air flow which passes through the intake opening and flows through the sheet conveying path.

3. An image forming system according to claim 2, wherein the intake opening is arranged in a side surface of the sheet conveying apparatus in a width direction, which is orthogonal to the sheet discharge direction, of the sheet.

4. An image forming system according to claim 2, wherein the air flow generator includes an air blower configured to send the outside air sucked through the intake opening toward the sheet conveying path.

5. An image forming system according to claim 1, further comprising an exhaust opening through which air passed through the sheet conveying path is discharged to outside of the image forming system.

6. An image forming system according to claim 5, wherein the air flow generator includes an exhaust portion configured to send the air passed through the sheet conveying path toward the exhaust opening.

7. An image forming system according to claim 1, wherein the air flow generator includes a blower fan configured to blow air toward the sheet conveying path.

8. An image forming system according to claim 7, wherein the air flow generator includes an exhaust fan configured to discharge air inside the sheet conveying path.

9. An image forming system according to claim 1, wherein the air flow generator causes the air passed through the sheet conveying path to enter the sheet processing apparatus.

10. An image forming system according to claim 1, wherein the air flow generator causes the air passed through the sheet conveying path to enter the image forming apparatus.

11. An image forming system according to claim 1, wherein the sheet conveying apparatus includes:
a sheet conveying portion configured to convey the sheet;
a first guide portion opposed to one surface of the sheet which is conveyed by the sheet conveying portion;
a second guide portion opposed to an other surface of the sheet which is conveyed by the sheet conveying portion to form the sheet conveying path between the first guide portion and the second guide portion;
an opening portion formed in at least one of a guide surface of the first guide portion and a guide surface of the second guide portion; and
a guide portion configured to guide the air flow generated by the air flow generator to the sheet conveying path through the opening portion.

12. An image forming system according to claim 11, wherein the image forming portion includes:
a transfer portion configured to transfer a toner image to the sheet; and
a heating portion configured to heat the toner image transferred to the sheet, and
wherein the opening portion and the guide portion are arranged so that the air flow generated by the air flow generator flows, with respect to the sheet which passes through the sheet conveying path, toward a surface of the sheet to which an image is last transferred by the transfer portion before the sheet is discharged from the image forming apparatus.

13. An image forming system according to claim 1, wherein the image forming apparatus includes:
a main body configured to house the image forming portion; and
an image reading portion, which is arranged above the main body, and is configured to read image information from an original, and
wherein the sheet conveying apparatus is mounted between the image reading portion and the main body.

14. A sheet conveying apparatus configured to convey a sheet discharged from an image forming apparatus to a sheet processing apparatus, the sheet conveying apparatus comprising:
a housing removably mounted to the image forming apparatus;
a sheet conveying portion configured to convey the sheet discharged from the image forming apparatus to the sheet processing apparatus, which is arranged to be opposed to a side surface of the image forming apparatus;
a guide portion, which forms a sheet conveying path through which the sheet is conveyed by the sheet conveying portion; and
an air flow generator configured to generate an air flow which flows through the sheet conveying path.

15. An image forming system comprising:
an image forming apparatus including:
an image forming portion configured to form an image on a sheet; and
a discharge portion configured to convey and discharge, in a sheet discharge direction, the sheet on which the image has been formed by the image forming portion;
a sheet processing apparatus, which is arranged to be opposed to a side surface of the image forming apparatus on a downstream side in the sheet discharge direction, and is configured to process the sheet;
a sheet conveying apparatus, which includes a sheet conveying path through which the sheet is conveyed, is removably mounted to the image forming apparatus, and is configured to convey the sheet discharged from the discharge portion to the sheet processing apparatus through the sheet conveying path; and
an air blower configured to blow air toward the sheet conveying path so that the air flows through the sheet conveying path.

16. An image forming system according to claim 1, wherein the image forming portion includes:
a transfer portion configured to transfer a toner image to the sheet; and
a heating portion configured to heat the toner image transferred to the sheet,
wherein the sheet conveying apparatus includes:
a sheet conveying portion configured to convey the sheet;
a first guide portion opposed to a first surface of the sheet witch is conveyed by the sheet conveying portion;
a second guide portion opposed to a second surface of the sheet which is conveyed by the sheet conveying portion to form the sheet conveying path between the first guide portion and the second guide portion; and
an opening portion formed in a guide surface of the first guide portion,
wherein the first surface of the sheet is a surface to which an image is last transferred by the transfer portion before the sheet is discharged from the image forming apparatus, and
wherein the air flow generator includes an air blower configured to blow air into the sheet conveying path through the opening portion.

17. An image forming system according to claim 15, wherein the image forming portion includes:
a transfer portion configured to transfer a toner image to the sheet; and
a heating portion configured to heat the toner image transferred to the sheet,
wherein the sheet conveying apparatus includes:
a sheet conveying portion configured to convey the sheet;
a first guide portion opposed to a first surface of the sheet which is conveyed by the sheet conveying portion;
a second guide portion opposed to a second surface of the sheet which is conveyed by the sheet conveying portion to form the sheet conveying path between the first guide portion and the second guide portion; and
an opening portion formed in a guide surface of the first guide portion,
wherein the first surface of the sheet is a surface on which an image is last transferred by the transfer portion before the sheet is discharged from the image forming apparatus, and
wherein the air flow generator includes an air blower configured to blow air into the sheet conveying path through the opening portion.
